(19) United States
(12) Patent Application Publication
(10) Pub. No.: US 2015/0113032 A1
(43) Pub. Date: Apr. 23, 2015

(54) METHOD AND SYSTEM FOR QUANTIFYING BINARY WORDS SYMMETRY

(71) Applicant: Lahcen Abellaoui, Cairo (EG)

(72) Inventor: Lahcen Abellaoui, Cairo (EG)

(21) Appl. No.: 14/377,944

(22) PCT Filed: Jun. 18, 2012
(86) PCT No.: PCT/IB12/53065

§ 371 Date: Aug. 11, 2014

(51) Int. Cl. G06F 17/16

(52) U.S. Cl. CPC G06F 17/16
USPC 708/520

(57) ABSTRACT

The present invention provides an innovative method and system for quantifying the binary words symmetry. Information of all kinds is necessarily interpreted by binary words. Quantifying the symmetry of these binary words, regardless of their size, is a new approach that makes available a new measure that can better appreciate the complexity, the information, the redundancy or the physical structure contained in each binary word and hence, in its source. Binary numbers processing can, thanks to this measure, have new tools for new approaches in many areas such as Information Theory and Theory of Symmetry which plays a significant role in Mathematics, Chemistry, Biology, Crystallography, etc. This method is based on computational system that generates the concerned ‘Symmetric Value’ of any binary number as well as its two amazing ‘Symmetric Value Matrixes’ which do not require storage to be known, regardless of their size.

A—Symmetry of 2^{N} Bits Binary Words

Definition: The Symmetric Value of binary words is defined by the character S. Any binary number defined by 2^{N} bits can take 2^{N} levels of symmetry quantified from 1 to 2^{N}. A binary number defined by 2^{N} bits whose Symmetric Value is:

S=2^{N}

means that it has a maximum Symmetric Value and that it is only defined by zeros or ones. A binary number defined by 2^{N} bits whose Symmetric Value is:

S=1

means that it has a minimum Symmetric Value and that the number of its zeros and ones are necessarily odd.

Quantifying Instrument: this method corresponds to the measuring instrument that will allow our system to quantify the Symmetric Value of any 2^{N} binary number, whatever N. It consists of measuring the faculty of any binary number to reach more or less rapidly one of the two binary words with maximum symmetry (only zeros or only ones) through a defined binary iteration.

Quantifying Instrument to maximum symmetry composed of 0's: this method consists in applying to all 2^{N} binary number a binary operation based on the concept of loop. The result of this operation is a new binary word which is visibly more symmetric. And the repetition of this operation leads to binary number with higher Symmetric Value till the binary number composed only of zeros. The Symmetric Value of any 2^{N} binary number is then defined as follows, where I is the number of binary loop operations or iterations required to reach the 2^{N} binary number only composed of zeros.

S=2^{N}−I

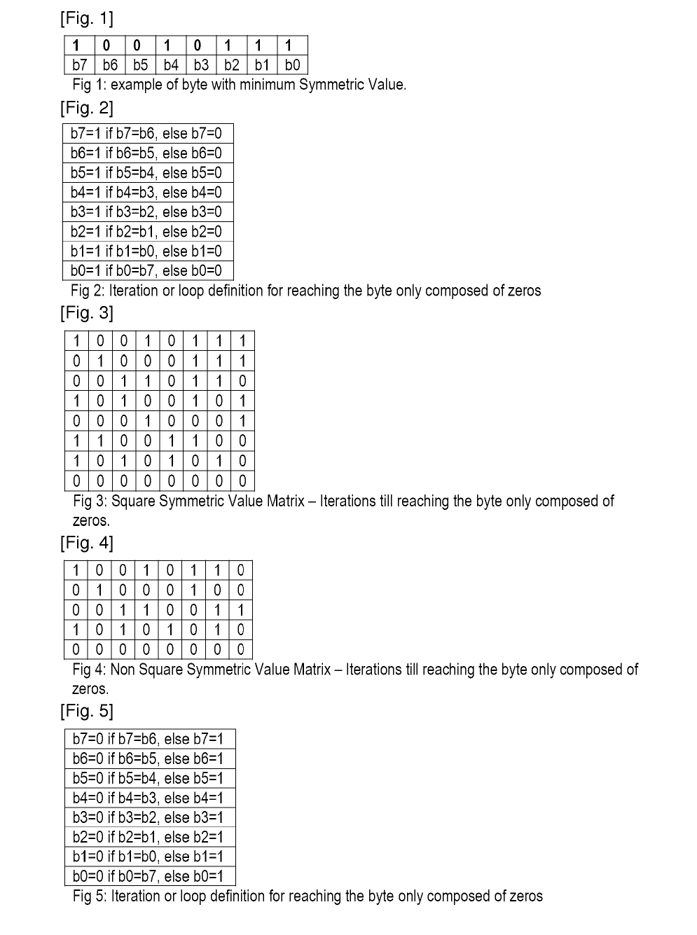

The following example shows how a byte (N=3) reaches the ultimate byte with maximum Symmetric Value only composed of zeros and how its Symmetric Value is calculated. The concerned byte is defined in FIG. 1 by the bits b0 to b7. The binary loop operation or iteration to apply to this byte is based on the FIG. 2 definitions. This operation has to be repeated till getting the byte only composed of zeros as shown in the Square Symmetric Value Matrix defined in FIG. 3. Seven iterations (I=7) have been required to reach the byte with maximum Symmetric Value; the system can then calculate the Symmetric Value of that byte:

S=2^{N}−I=1

Another example is shown in the Non Square Symmetric Value Matrix defined in FIG. 4. Four iterations (I=4) have been required to reach the byte with maximum Symmetric Value; the system can then calculate the Symmetric Value of this byte (10010110):

S=2^{N}−I=4

Note also that any 2^{N} binary number can be represented, thanks to this new approach, by only:

(2^{N}−S) bits.

In our first example, the byte 10010111 can be represented by the binary word of 7 bits 1001011 (first column of the matrix without the 0 of the maximum symmetry byte). And in our second example, the byte 10010110 can be represented by the binary word of 4 bits 1001 (first column of the matrix without the 0 of the maximum symmetry byte). This shows that binary words with higher Symmetric Value have more redundant data.

Quantifying Instrument to maximal symmetry composed of 1's: this Symmetric Value measure is here based on the same principle as before and gives the same Symmetric Value for the same binary word. The only difference is that the binary loop operations or iterations leads to the binary number composed only of 1's and, in these conditions, Symmetric Value Matrixes are different.

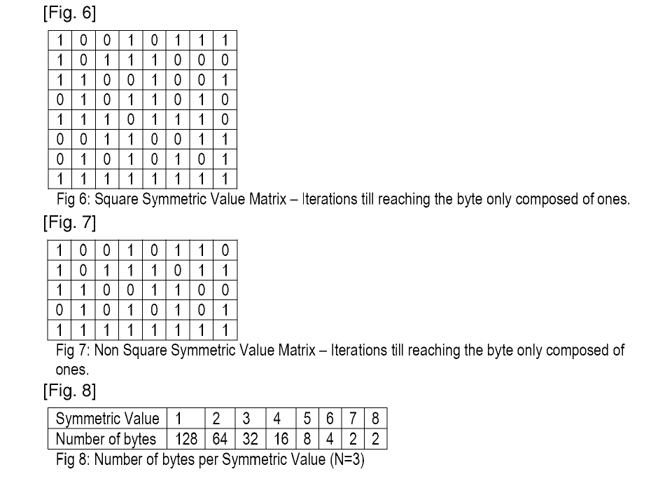

The following example shows how the byte (N=3) defined in FIG. 1 reaches the byte with maximum Symmetric Value only composed of 1's. The binary loop operation or iteration to apply to this byte is based on the FIG. 5 definitions. This operation has to be repeated till getting the byte only composed of ones as shown in the Square Symmetric Value Matrix defined in FIG. 6. Seven iterations (I=7) have been required to reach the byte with maximum Symmetric Value; the system can then calculate the Symmetric Value of that byte:

S=2^{N}−I=1

Another example is shown in the Non Square Symmetric Value Matrix defined in FIG. 7. Four iterations (I=4) have been required to reach the byte with maximum Symmetric Value; the system can then calculate the Symmetric Value of this byte (10010110):

S=2^{N}−I=4

Note also that any 2^{N} binary number can be represented, thanks to this new approach, by only:

(2^{N}−S) bits.

In our first example, the byte 10010111 can be represented by the binary word of 7 bits 110100 (first column of the matrix without the 1 of the maximum symmetry byte). And in our second example, the byte 10010110 can be represented by the binary word of 4 bits 1100 (first column of the matrix without the 1 of the maximum symmetry byte). This shows that binary words with higher Symmetric Value have more redundant data.

Conclusion: Any binary number defined by 2^{N} bits have its own Symmetric Value defined by our previous method of quantifying. This value is between 1 and 2^{N} (1 and 8 for a byte). The table defined in FIG. 8 shows, for N=3, the number of bytes for each Symmetric Value.

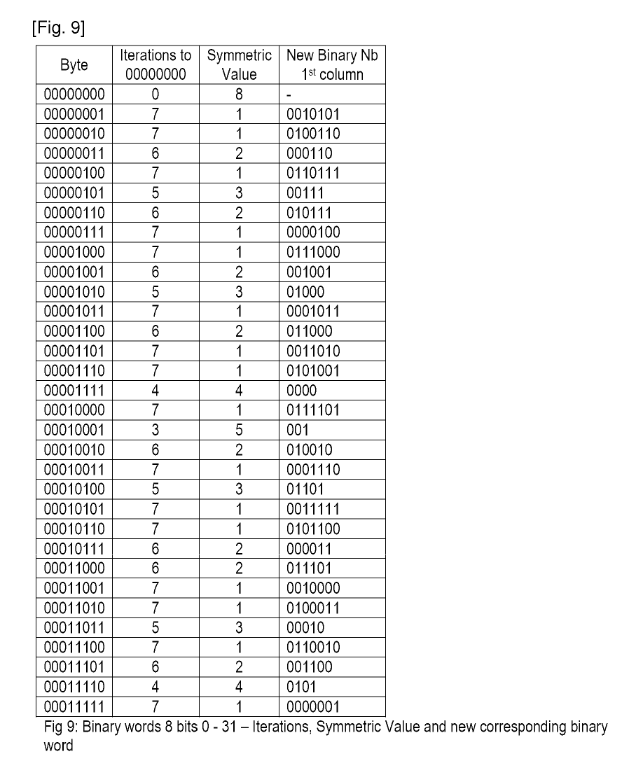

This Symmetric Value is defining a real geometric symmetry of the concerned binary number. As a matter of fact, the FIGS. 9 till 16 show, for each byte, its Symmetric Value as well as its new length. This example is based on iterations leading to byte 00000000.

### B—Symmetry of P Bits Binary Words

Definition: Any binary number defined by P bits (P#2^{N}, odd or even) can take P levels of symmetry quantified from 1 to P. A binary number defined by P bits whose Symmetric Value is:

S=P

means that it has a maximum Symmetric Value and that it is only defined by zeros or ones. A binary number defined by P bits whose Symmetric Value is:

S=1

means that it has a minimum Symmetric Value.

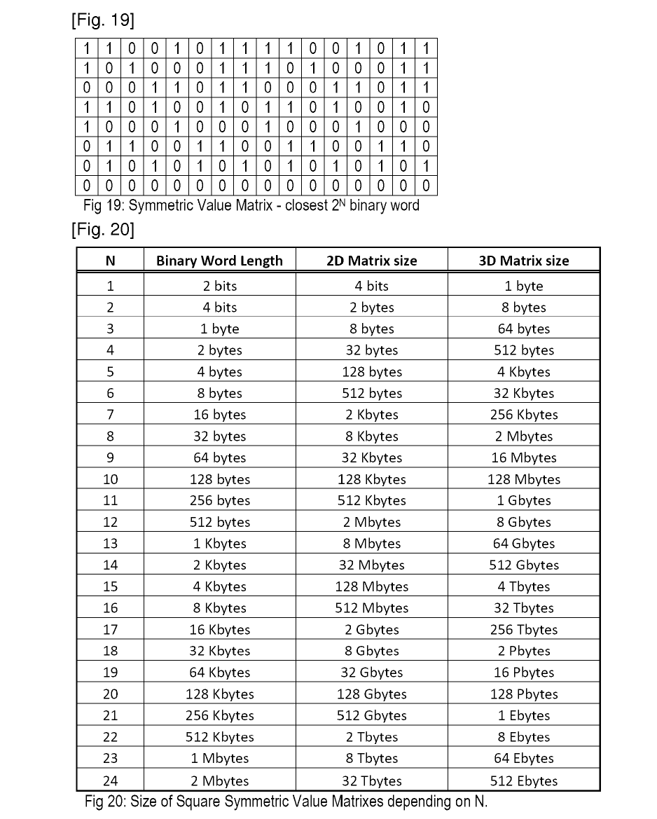

Quantifying Instrument: this method corresponds to the measuring instrument that will allow our system to quantify the Symmetric Value of any P bits binary number (P#2^{N}, odd or even), whatever P. This method is based on the same principle as for 2^{N} binary numbers. In fact, the first operation to apply to any P bits binary number is to convert it to the closer 2^{N} binary number, with 2^{N}>P. This operation has to lead to the higher Symmetric Value. The binary number defined in FIG. 17 is, for example, converted to the closest 2^{N} binary word defined in FIG. 18, which leads to the Symmetric Value Matrix defined in FIG. 19 (Symmetry to zeros). Seven iterations (I=7) have been required to reach the 16 bits number with maximum Symmetric Value; the system can then calculate the Symmetric Value of that byte:

S=P−I=2

### C—Example of Cryptographic Application

Introduction: many aspects of the Symmetric Value Matrixes (especially when these matrixes are concerning 2^{N} binary numbers with minimal Symmetric Value—Square Symmetric Value Matrixes) are interesting for the Cryptography Domain. However, we will focalize here in the following aspect: when the number N is growing, these symmetric value matrixes are becoming huge; these matrixes can be defined in 2D or 3D. The table in FIG. 20, with N limited to 24, shows the size of such matrixes. However, and despite the huge size of these matrixes, only the first binary word has to be known—hence his storage—in order to access the entire matrixes. We can also, from these matrixes, to generate new binary words with desired length that will be the base of new huge matrixes. In these conditions, the knowledge of one binary word can open the access of an unlimited amount of data. The cryptographic technic presented here is based on that principle which is the access and sharing of an unlimited amount of data which can change at any time and without the need to sore it.

Cryptographic Principle: the Primary Matrix is a 2^{N} Symmetric Value Matrix with N=24 (see FIG. 20) which is defined by 32 Tbytes size in 2D version and 512 Ebytes in 3D version. For us, this matrix is simply defined by 2^{N} binary number with N=24, and a size of 2 Mbytes (2,097,152 bytes or 16,777,216 bits). This matrix (or this binary word) is accessible to any person who wants to use this cryptographic system. Let's say that two persons who knows this binary word and hence the Primary Matrix need to exchange in a secure way data. The first step is to generate a new binary number which will be the base to their personal matrix. For that, they will have to exchange two values:

The coordinates X, Y and Z of the Primary Matrix; these coordinates will define the first bit of their new 2^{N} binary word (6 to 9 bytes).

The value of N; this value can be higher or lower than 24 according to the amount and type of data to exchange (1 byte)

This step which consists in the exchange of 7 or 10 bytes has to be done in a strict confidentiality (as for the credit cards password); the confidentiality of this step will guarantee the INVIOLABILITY of the future exchanges of our two persons.

Data Exchange: as soon as the new binary number is defined by the two persons, the exchange can start by drawing characters contained in their Personal Matrix. Each one of these characters (used only once) is defined by its coordinates inside this matrix;

At any time, the exchange can concern a new binary number and hence a new Personal Matrix.

Data Confidentiality: the principle of this method is based on the use of an infinite amount of data which is only accessible by our two persons. Only coordinates are transmitted and never twice. In these conditions there is no correspondence between the transmitted character and used coordinates as the same character can have different coordinates and the same coordinate can define different characters.

### D—Example of Data Compression Application

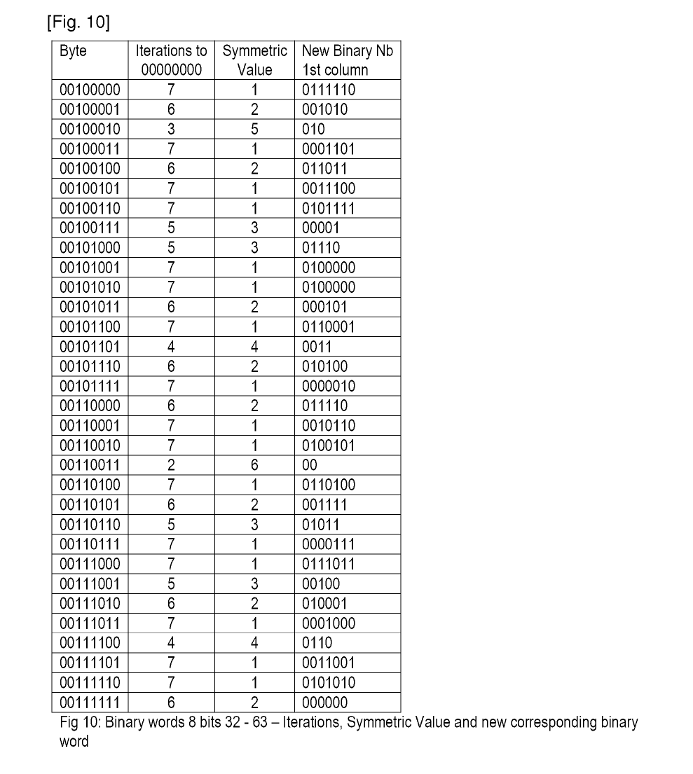

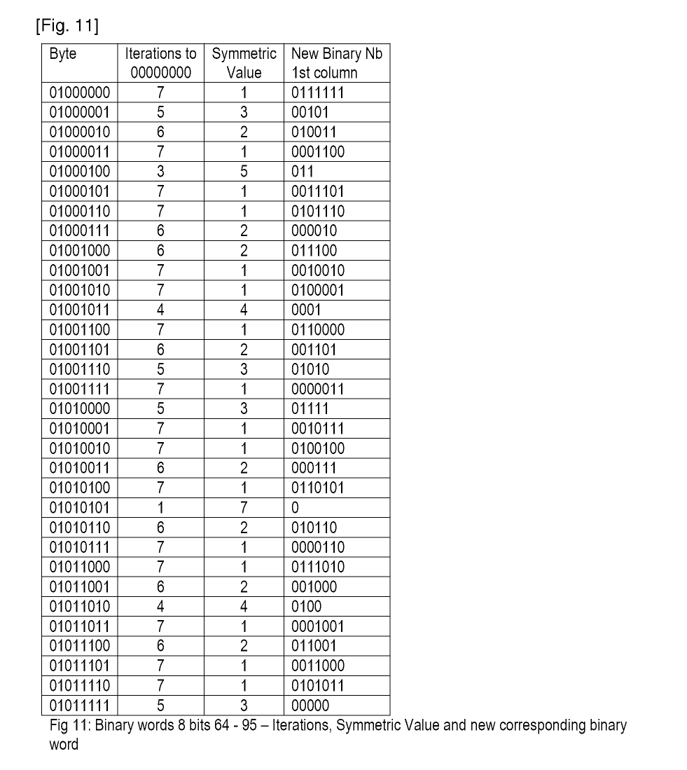

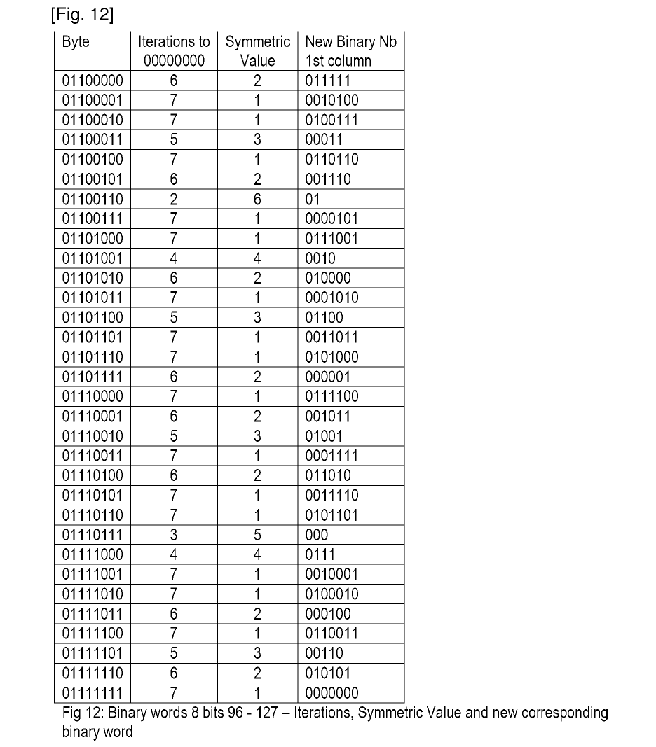

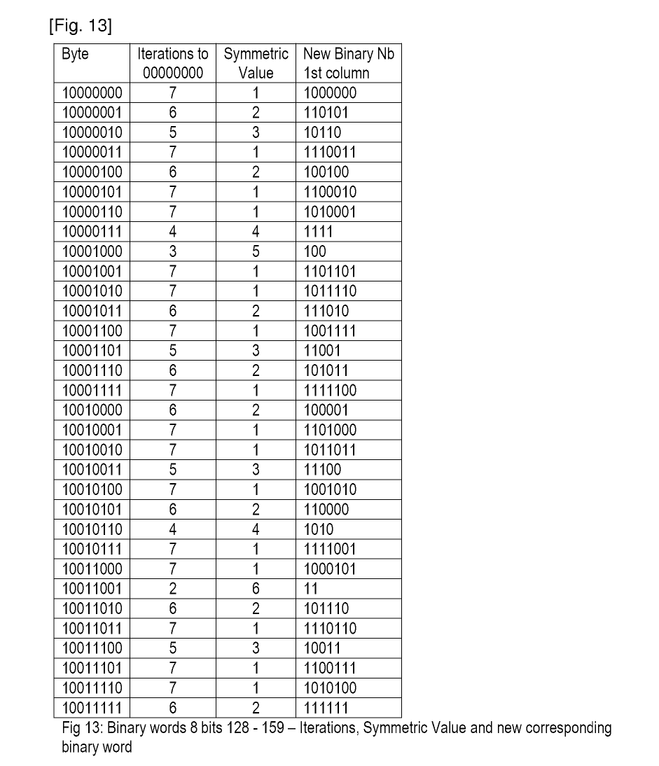

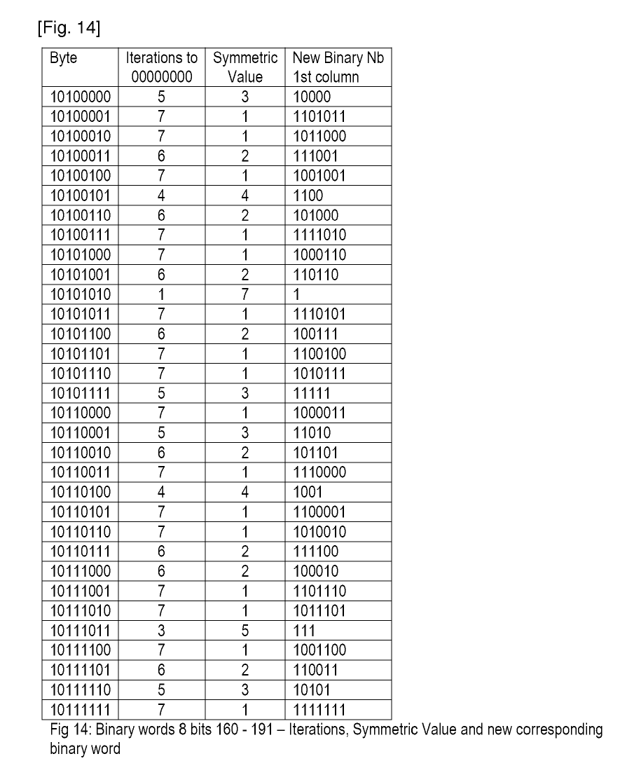

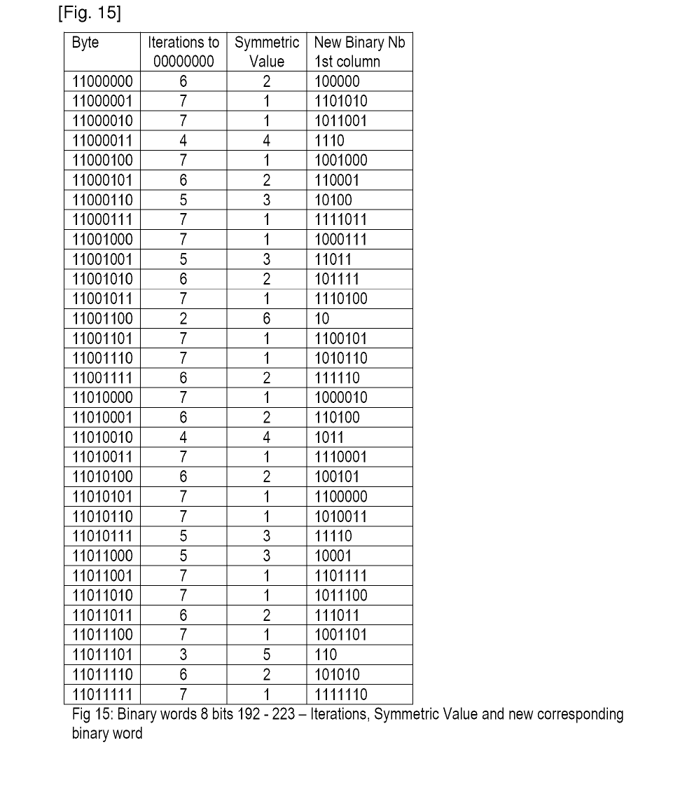

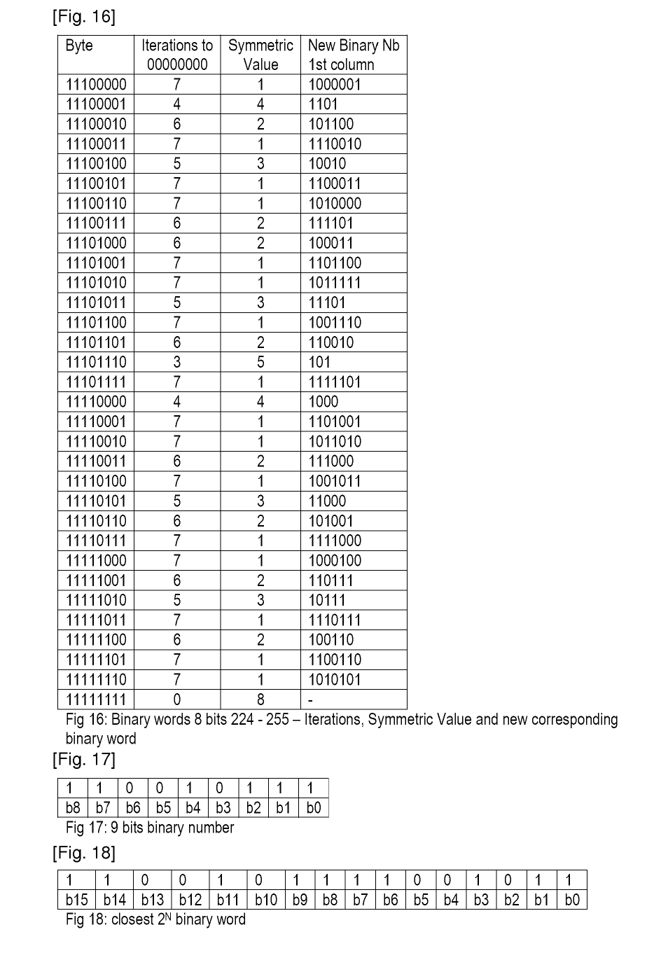

Introduction: more a binary word is symmetric and more it is compressible. The FIGS. 9 to 16 show that each byte can be defined by a new binary number with lower length directly linked with its Symmetric Value. Example: the byte 01001011 has a Symmetric Value 4 and can be converted to a new reduced binary number of 4 bits: 0001 (symmetry to 0) or 0110 (symmetry to 1). As a general rule, any 2^{N} bits binary number is convertible to a new binary number with length C lower than 2^{N} bits and as defined by the following formula; it is this aspect of binary numbers symmetry that will be used in our following example.

C=2^{N}−S

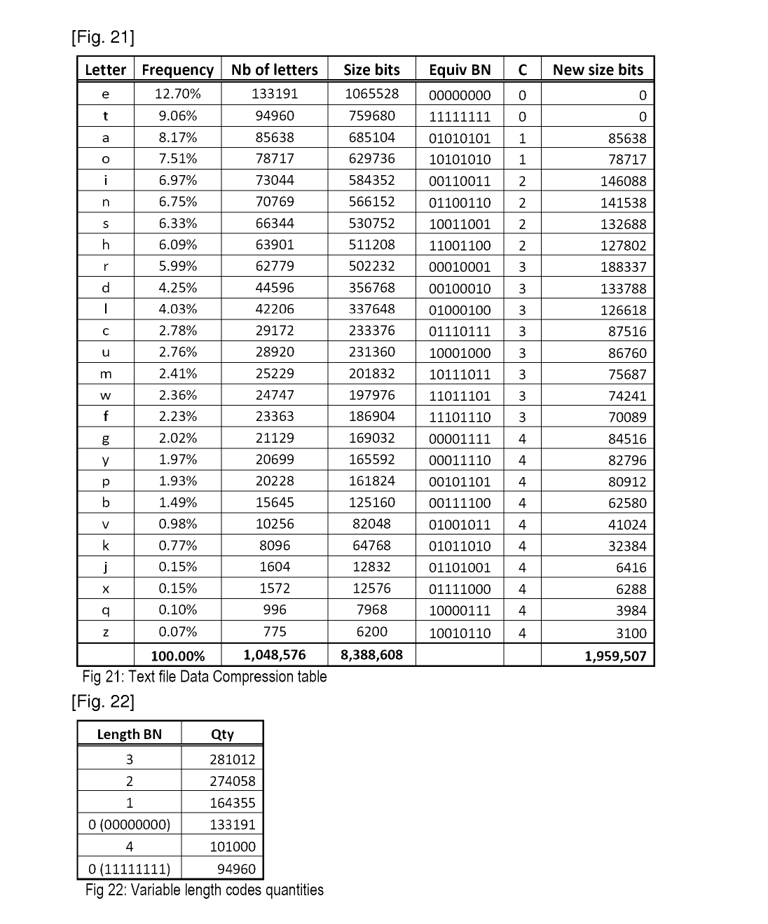

Text files compression: this example shows how we can compress text files by using one of the aspects of the binary numbers seen before. Let an English text file with size 1 MB based only on letters with frequencies defined in FIG. 21: This figure also defines the following:

Each letter contained in the file and its frequency

Number of letters corresponding to this frequency

Size of these letters in bits.

The following column ‘Equiv BN’ shows the symmetric binary number which will replace the corresponding letter. In fact, the goal here is to substitute the more frequent letters to the more symmetric binary numbers, C being their length. The new size of substituted binary numbers is also given and we notice that the file goes from 8,388,608 bits to 1,959,507 bits. It is obvious that at this stage, we have replaced binary words (or letters) by other binary words with variable length (from 0 to 4 bits) and that we will need, at the time of primary file reconstitution, to be able to separate these variable length words. We will use the spatial method which gives us the position of any of the 1 Mbytes according to its length. We have normally, for each length, the following quantities in FIG. 22:

The different following binary numbers will provide us the spatial position according to binary word length:

A first binary word of 1 Mbits that corresponds to the 1 Mbytes with only 1's where binary word with C=3 are present. Number of 1's is then 281,012.

A second binary word of 767,564 bits (1 Mbits-281,012) with only one's where binary word with C=2. Number of 1's is then 274,058.

A third binary word of 493,506 bits (767,564-274,058) with only one's where binary word with C=1. Number of 1's is then 164,355.

A fourth binary word of 329,151 bits (493,506-164,355) with only one's where binary word with C=0 (00000000). Number of 1's is then 133,191.

A fifth and last binary word of 195,960 bits (329,151-133,191) with only one's where binary word with C=4. Number of 1's is then 101,000. Remaining zeros are corresponding to binary words with C=0 (11111111).

The summation of these five binary words is 2,834,757 bits and then a total of 4,794,264 bits if we add them to the 1,959,507 bits of compressed bytes. Ultimately is a compression ratio of around 0.57 (4,794,264/8,388,608). Note also that this compressed file can be compressed again in the same way knowing that it has redundant bytes especially 00000000.

What is claimed is:

1. A “method and System” for quantifying the binary words symmetry and its applications.

2. The method recited in claim 1 wherein the binary words are considered as a loop and iterated till obtaining the binary words with maximum symmetry only comprising zeros or ones.

3. A “Symmetric Value Matrixes” which are representing an infinite amount of available data that don't need to be stored for being known.
